(19) United States
(12) Patent Application Publication
(10) Pub. No.: US 2025/0353390 A1
(43) Pub. Date: Nov. 20, 2025

(54) Loading or Tank Trough Arrangement with Display Panel

(71) Applicant: Illinois Tool Works Inc., Glenview, IL (US)

(72) Inventors: Roland Och, Rottendorf (DE); Thomas Rader, Pliezhausen (DE); Martha Canelada, Renningen (DE); Matthias Hegwein, Ippesheim (DE)

(21) Appl. No.: 19/189,529

(22) Filed: Apr. 25, 2025

(30) Foreign Application Priority Data
May 14, 2024 (DE) 10 2024 113 415

(51) Int. Cl. B60L 53/16; B60K 15/04

(52) U.S. Cl. CPC B60L 53/16; B60K 15/04; B60K 2015/0461

(57) ABSTRACT

The disclosure relates to a charging or fueling compartment assembly (1) for a vehicle. The charging or fueling compartment assembly (1) includes a charging or fueling compartment (2) and a cover. The charging or fueling compartment assembly (1) further includes an indicator panel (4) for indicating as needed at least one icon (5), the indicator panel (4) includes at least one light source associated with the at least one icon (5) to be indicated as needed, and the indicator panel (4) is configured as a hidden-until-lit component, in which the at least one icon (5) to be indicated as needed is only visually perceptible when the at least one light source associated with the at least one icon (5) to be indicated as needed is active.

### RELATED APPLICATION

The present application claims the benefit of German Patent Application No. 10 2024 113 415.1, filed May 14, 2024, titled “Loading or Tank Trough Arrangement with Display Panel,” the contents of which are hereby incorporated by reference.

### BACKGROUND

Vehicles with a hybrid or electric drive have at least one battery or traction battery, which, for example, in the case of PHEV (Plug-In Hybrid Electrical Vehicle) or BEV (Battery Electric Vehicle) vehicles, can be charged via an electrical charging connection that is accessible from the outside of the vehicle body or on the vehicle outer skin, which is usually a charging box, can be charged by connecting it to an electric charging station or a conventional domestic power supply, for example.

The charging connection is usually located in a charging recess in the vehicle body or vehicle outer skin, which is normally covered or closed by a sealing element (also referred to below as a “cover”). A mechanism interacting with the closure element or the cover allows the charging bay to be opened and closed or the closure element (if designed as a charging flap) to be opened and closed relative to the charging bay, thus providing access to the charging connection.

The mechanism can, for example, include push-push kinematics, as already used in conventional fuel caps. Since, in practice, a seal is usually missing between the locking element and the charging tray when using such a push-push mechanism, which would, however, be necessary to protect the electrical charging connection, which has metallic contacts, from the ingress of dirt, dust, and liquids, in particular water, and thus ensure its long-term function, an additional charging connection flap is currently required, which is placed or screwed onto the charging connection to protect it.

By contrast to internal combustion engine vehicles, which are typically filled with fuel at gas stations where the fueling operation occurs either during the day or in an illuminated environment, the charging operation often occurs in the dark in vehicles having a hybrid or electric drive. For example, it is common for a vehicle having a hybrid or electric drive to be recharged in a dark, non-illuminated, underground parking lot. In this case, it is extremely advantageous if the operator or driver can find the charging plug connector in the charging recess more easily with the help of suitable lighting. For this purpose, it is known to provide illumination in the charging recess.

It can also be provided that light sources are arranged around the charging connector in the charging recess in order to identify the charging connector. For example, DE 10 2011 108 817 A1 describes a charging device for an electric vehicle in which segment-like light sources are arranged around the charging plug connector in the charging recess in such a way that they form a closed ring around the charging plug connector. The LEDs serve to illuminate the charging connector and also provide a kind of scale that can be used to visualize the state of charge of an electric vehicle battery.

Accordingly, it can be seen that loading or fueling compartment assemblies of a vehicle in particular must have different functionalities: on the one hand, it is preferable that appropriate lighting is provided, in particular to illuminate an area of a loading or fueling compartment of the loading or fueling compartment assembly. This lighting should preferably also visualize a state of charge of a battery of the vehicle to be charged. On the other hand, it is common or desirable for a position of a cover of the charging or fueling compartment assembly to be detected or monitored. This applies in particular to vehicles that have several charging or fueling compartment assemblies, for example on the port side and the starboard side of the vehicle. For such vehicle types, it shall be ensured that the cover of the charging or fueling compartment assembly not used for charging the vehicle battery is securely closed with the appropriate cover to prevent access to a charging box of that charging or fueling compartment assembly.

However, even for vehicle types that have only a single cargo or fueling compartment assembly, the detection of a position of the cover of the cargo or fueling compartment assembly is desirable to ensure that the cargo or fueling compartment of the vehicle is securely closed when the vehicle is in operation. The cover, on the other hand, can usually also assume different states, especially in the closed position of the cover. This, for example, is an unlocked state in which the cover can be moved from the closed position to the open position either manually or by an electric motor, and a locked state in which the cover cannot be moved from the closed position to the open position. The cover's state (unlocked/locked) is often controlled by an electric motor. It would also be desirable to be able to record the condition of the cover.

Further functionalities of a charging or fueling compartment assembly exist. As an example, the cover of the charging or fueling compartment assembly can often be moved by electric motor from its closed position to the open position and/or vice versa. Another example is monitoring the charge state of the vehicle battery.

It should therefore be noted that vehicle components, such as charging or fueling compartment assemblies, have a variety of functionalities. The functions of the charging or fueling compartment assembly are usually controlled by at least one electric motor actuator (often also by several electric motor actuators). In addition, control of the lighting/illumination of the charging or fueling compartment is desired, as well as optional control of the charging status display.

This example shows that the individual vehicle components must increasingly take on various functions that need to be controlled appropriately. The control of the individual functions of the vehicle component, such as a charging or fueling compartment assembly, is usually carried out depending on the detection results of a sensor system. For example, in the case of a charging or fueling compartment assembly, a sensor system can be used in particular to detect a position of the cover of the charging or fueling compartment assembly and/or to detect a state of the cover (unlocked state/locked state).

To indicate the individual states and functions of the charging or fueling compartment assembly to the user, conventional charging or fueling compartment assemblies often use light fields, as is known, for example, from the aforementioned publication DE 10 2011 108 817 A1. It is common for the light sources to emit light with different wavelengths to indicate the corresponding states.

However, this conventional approach reaches its limits when it comes to the charging or fueling compartment assemblies if several different functionalities of the charging or fueling compartment assembly are to be visualized. Although it is conceivable, for example, to vary the flashing frequency of the light emitted by the illuminants to indicate other states or functions of the charging or fueling compartment assembly, it is often not intuitively recognizable to the user which information is ultimately indicated by the illuminants.

With conventional charging or fueling compartment assemblies, a kind of concordance table is provided, for example on an articulated arm that connects the cover of the charging or fueling compartment assembly with the charging or fueling compartment, with the help of which the user can “translate” the signal emitted by the light source. However, this approach is also unsatisfactory because the corresponding concordance table often has to be relatively small and thus illegible. Furthermore, it is not guaranteed that the table will remain legible over time.

On the basis of this problem, the present disclosure is thus based on the task of specifying a charging or fueling compartment assembly for a vehicle, wherein the charging or fueling compartment assembly is wherein various functionalities exist which are displayed to the user in an easily understandable intuitive manner.

### SUMMARY

The present disclosure relates generally to a charging or fueling compartment assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically shows an exemplary embodiment of the charging or fueling compartment assembly according to the disclosure, in which the cover of the charging or fueling compartment assembly is in its open position and in which the indicator panel of the charging or fueling compartment assembly is not activated.

FIG. 2 illustrates schematically shows the exemplary embodiment of the charging or fueling compartment assembly according to the disclosure as shown in FIG. 1, in which, however, the indicator panel is activated and all the icons on the indicator panel are optically perceptible.

FIG. 3 illustrates a schematic and sectional view of the exemplary embodiment of the charging or fueling compartment assembly according to the disclosure, as shown in FIG. 1.

FIG. 4 illustrates a schematic rear view of the exemplary embodiment of the charging or fueling compartment assembly according to FIG. 1.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a charging or fueling compartment assembly for a vehicle. M ore particularly, the disclosure relates in particular to a charging or fueling compartment assembly for a vehicle, the charging or fueling compartment assembly having a charging or fueling compartment for insertion into an opening of a vehicle body or into an opening of a vehicle outer skin, and a cover which is operatively connected to a mechanism in such a way that the cover can be transferred relative to the charging or fueling compartment between a closed position covering the charging or fueling compartment at least partially or zonally and an open position releasing the charging or fueling compartment at least partially or zonally.

The charging or fueling compartment assembly according to the disclosure is characterized in particular by the fact that it also has an indicator panel for displaying at least one icon as needed. The icon to be displayed as needed is, for example, a mark, a sign, a picture, a letter, a word, or the like.

The indicator panel has at least one light source assigned to each of the icons that may need to be displayed. The light source is in particular at least one LED or one light-emitting diode or one light-emitting film, although other light sources are also fundamentally suitable.

In particular, the indicator panel is designed as a so-called hidden-until-lit component, in which the at least one icon to be displayed as needed is only optically perceptible when the at least one light source associated with the at least one icon to be displayed as needed is active.

The advantages of the solution according to the disclosure are obvious: by providing an indicator panel, it is possible in an easy-to-implement yet effective manner to indicate different states or functions of the charging or fueling compartment assembly to the user of the charging or fueling compartment assembly in an intuitive manner, that is, in an easily understandable manner. On the other hand, the provision of the indicator panel means that the corresponding light sources can be dispensed with. This simplifies the entire structure of the charging or fueling compartment assembly and in particular the necessary sealing of the individual lamp outlets in the conventional approach of a charging or fueling compartment assembly. The indicator panel can be integrated into the charging or fueling compartment in such a way that it is dust and moisture-proof when inserted/integrated into the charging or fueling compartment.

Preferably, the indicator panel includes a variety of icons to be displayed as needed. For example, the indicator panel can have at least one first icon for indicating a position of the cover of the charging or fueling compartment assembly as needed, at least one second icon for indicating a state of the cover as needed, at least one third icon for indicating a charging state as needed, at least one fourth icon for indicating a state in which a charging box is inserted into a charging socket of the charging or fueling compartment assembly and is arrested there if appropriate, at least one fifth icon for indicating, as needed, a charging duration and/or a remaining charging duration, at least one sixth icon for indicating, as needed, a state in which an A C charging or a DC charging is taking place, and/or at least one seventh icon for displaying, as needed, a status of at least one charging connection of the charging or fueling compartment assembly or for displaying, as needed, a status of at least one charging connection of a second (additional) charging or fueling compartment assembly of the vehicle.

The charging or fueling compartment assembly preferably has a sensor system. Alternatively, however, it is also conceivable that a sensor system is assigned to the charging or fueling compartment assembly, wherein the sensor system does not necessarily have to be part of the charging or fueling compartment assembly.

In principle, the sensor system comprises at least one sensor and/or switch, in particular a microswitch, which is designed in particular to detect a position, in particular the closed position, open position, and/or at least one intermediate position, of the cover, to detect a state of the cover, in particular a locked state and/or an unlocked state of the cover, to detect a state in which a charging box is inserted into a charging socket of the charging or fueling compartment assembly and is arrested there if appropriate, and/or to detect a charging state.

In this context in particular, it is useful for the charging or fueling compartment assembly to have a control device. Alternatively, it is also conceivable that a control device is assigned to the charging or fueling compartment assembly, in particular if the control device is not part of the charging or fueling compartment assembly.

In principle, the control device should be designed, in particular, depending on a state detected by the sensor system, to activate or deactivate the at least one light source associated with the at least one icon to be displayed as needed, to change a brightness of the light emitted by the at least one light source associated with the at least one icon to be displayed as needed, change a color of the light emitted by the at least one light source associated with the at least one icon to be displayed as needed, and/or change a flashing frequency of the light emitted by the at least one light source associated with the at least one icon to be displayed as needed.

In a further development of the charging or fueling compartment assembly according to the disclosure, it is envisaged that the indicator panel is an integral part, in particular, of a user interface of the charging or fueling compartment assembly and has at least one control panel with at least one control element, in particular with at least one touch control element.

In this case, it is preferably provided that the at least one control element is designed to capacitively detect a touch by a user and/or the position of a touch by a user.

In this context, it is particularly useful if the at least one control element is also preferably designed as a hidden-until-lit component, in which the control element is only visually perceptible when a user interface light source associated with the at least one control element is active.

For example, the at least one control element can be designed as a pressure-sensitive slide switch, which is designed so that a parameter of a display field of the user interface is changed or can be changed when a user exerts pressure along the control element from one position to another.

The touch control element of the control panel of the indicator panel, for example, consists of a surface made of a glass-like material or a glass-like material with transparent, conductive elements on the inside of the surface, which are configured to detect the position of a user's touch in a capacitive manner. Touch controls of this kind have advantages over conventional controls such as buttons, levers, and push buttons, particularly with regard to dust- and waterproof integration in an area of the charging or fueling compartment.

When the control element is implemented as a slide switch, it is possible for the slide switch to have a layer with variable resistance that is configured to close a different circuit at each respective point of user-applied pressure and to open each circuit when the user-applied pressure is moved away from each point at which one of the circuits is closed. At the point where the user applies pressure, the resistance of the layer with variable resistance is lower than at points where the user does not apply pressure.

According to one aspect of the latter embodiments, it is in particular provided that the at least one control element is designed to give a haptic and/or acoustic feedback signal when it is actuated.

In principle, it is conceivable that the at least one control element of the control panel of the indicator panel is designed to activate or deactivate an actuator assigned to the cover of the charging or fueling compartment assembly, to activate or deactivate a lock assigned to the cover, to start, end, abort, or interrupt a charging process, and/or to activate or deactivate a charging box lock associated with a charging socket of the charging or fueling compartment assembly.

In accordance with further developments of the charging or fueling compartment assembly according to the disclosure, the indicator panel can have a display device for displaying a picture, in particular a changeable picture, as needed. The picture that can be changed in particular is either a static or a moving picture.

In this further development of the charging or fueling compartment assembly according to the disclosure, the display device should preferably also be designed as a hidden-until-lit component, in which the image is only optically perceptible when the display device is active.

Various design variants are possible for the display device. In particular, thin-film display devices are suitable, especially those that have an OLED, a TFT, an LCD, an ITO film display, or an SED display.

With regard to the structural design of the indicator panel of the charging or fueling compartment assembly according to the disclosure, it is envisaged, in accordance with the realizations of the present disclosure, that the indicator panel has a carrier for the at least one light source and a layered structure with a front side for displaying the at least one icon displayed or icon to be displayed and a rear side that can be illuminated by the at least one light source. To avoid crosstalk between an area of an icon to be displayed and an area of an icon not to be displayed, it is conceivable to provide an opaque crosstalk-reducing layer.

Alternatively or in addition to this, it is conceivable that the carrier is segmented for the at least one light source in such a way that the light emitted by a light source associated with a first icon only illuminates the area of the back of the layer structure in which the first icon (to be displayed) is formed, and that the light emitted by a light source associated with a second icon only illuminates the area of the rear side of the layer structure in which the second (to be displayed) icon is formed.

With regard to the layer structure of the indicator panel, it is conceivable that the layer structure has an at least partially or zonally translucent top layer and a stencil layer. The at least one icon to be displayed as needed is incorporated into the stencil layer, in particular by engraving, such as laser engraving or electroengraving. Alternatively, however, it is also conceivable that the at least one icon to be displayed as needed is applied to a surface of the stencil layer, in particular by printing, in particular inkjet printing or screen printing.

The term “translucent” or “translucent material” as used herein refers to a material that is somewhat transparent to light, such as frosted glass, but where the light can also be at least partially scattered or absorbed by material properties, so that colors, light and dark areas are recognizable, but not, for example, all the details of an icon.

The translucent top layer can be made of a translucent plastic, in particular polycarbonate (PC), polymethyl methacrylate (PMMA), polyamide (PA), UV-stabilized ABS, polypropylene (PP), or a translucent polymer or silicone, or glass or a glass material.

The translucent top layer preferably has a thickness of about 0.5 mm to about 2.0 mm.

In terms of light transmission T (transmittance), the translucent top layer should have a value of 5% to 70%, in particular 5% to 50%, and preferably 5% to about 15% for visible light.

The term “visible light” as used herein refers to light in a wavelength range from 400 nm to 700 nm.

It has been shown that even with a light source of relatively low luminosity, such as a 0.5 watt LED, a luminance of the area of the icon to be displayed of 2 to 4 cd/m2 (cd=Candela) and even of 2 to 5 cd/m2 and thus a good background illumination can be achieved, wherein the display system, as long as it is switched off, is not visually perceptible to the user from the outside.

In particular, the combination of the translucent cover layer and the template layer can have a light transmission T (transmission level) of, for example, 5% to 10% in the visible wavelength range. As a result, the translucent cover layer and the template layer, as well as the at least one light source, can be coordinated with each other in such a way that when the at least one light source is activated, the icon to be displayed is backlit to an intensity of, for example, 2 to 4 cd/m2 or 2 to 5 cd/m2 or 5 to 10 cd/m2 or about 4 cd/m2 or about 5 cd/m2.

Of course, other luminance levels are also possible, depending on the choice of light source and the translucent cover layer.

The translucent top layer can also be opaque zonally.

In a particularly alternative embodiment of the hidden-until-lit functionality of the indicator panel, the layer structure of the indicator panel is provided with an electrochromic layer with light-impermeable suspended particles, which can be electrically switched between a light-impermeable state and a transparent or translucent state, at least zonally, with the aid of electrical energy supplied by a voltage source.

In this context, it is conceivable that a separately controllable electrochromic layer is provided for each area of the indicator panel in which an icon to be displayed as needed is provided.

In the case of further training for the last-mentioned design variants, it is conceivable that the layer structure of the indicator panel has a stencil layer, wherein the at least one icon to be displayed as needed is incorporated in the stencil layer, in particular by engraving, such as laser engraving or electro-engraving, or is applied to a surface of the stencil layer, in particular by printing, in particular inkjet printing or screen printing.

Regardless of the question of how the layer structure of the indicator panel is ultimately designed, it is possible that the layer structure also has at least one color layer, preferably at least partially or zonally, in particular on the front or back of an upper covering layer.

The indicator panel is in particular accommodated in the charging or fueling compartment, preferably in a detachable or exchangeable manner, or integrated in the charging or fueling compartment.

The exemplary embodiment of the charging or fueling compartment assembly 1 according to the disclosure, shown in the drawings, comprises a charging or fueling compartment 2 which is inserted in an opening of a vehicle body 3. In addition, the charging or fueling compartment assembly 1 has a cover not shown in the drawings, which is operatively connected to a corresponding mechanism in such a way that the cover can be moved relative to the charging or fueling compartment 2 between a closed position covering the charging or fueling compartment 2 at least partially or zonally and an open position releasing the charging or fueling compartment 2 at least partially or zonally.

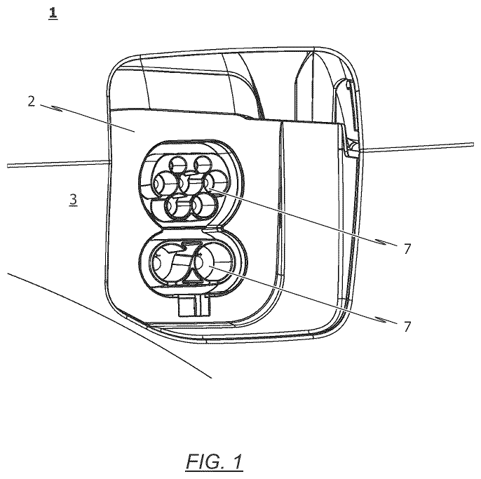

In FIG. 1 through FIG. 3, the charging or fueling compartment assembly 1 is shown in each case in a state in which the cover is in its open position.

In detail, in the charging or fueling compartment assembly 1 shown in the drawings, the cover is reversibly movable between a closed position, in which the cover is arranged in particular flush and preferably contour-flush with the vehicle body 3 and in particular with the vehicle outer skin, and an open position, in which the cover is arranged at least partially or zonally behind the vehicle body 3 and in particular the vehicle outer skin. For this purpose, the operating mechanism preferably has a drive, in particular in the form of an electric motor, with a drive shaft and a movement mechanism or linkage mechanism that is operatively connected in particular to the rear side of the cover and to the drive.

The actuating mechanism used for the charging or fueling compartment assembly 1 shown in the drawings may, in particular, be an actuating mechanism as described in publication DE 10 2023 103 567 A1.

Accordingly, the operating mechanism is, in particular, an operating mechanism which is able to move the cover between an open position and a closed position and vice versa, wherein the operating mechanism is, in particular, able to automatically uncover or cover an opening in the vehicle contour, for example in the vehicle body 3.

However, the present disclosure is not limited to charging or fueling compartment assembles 1, in which the cover, in its open position, is arranged at least partially or zonally behind the vehicle body 3 and, in particular, the vehicle outer skin. Rather, it is also conceivable in principle that the cover can be swung outwards when charging connections 7 are released and, for example, in an open state, can protrude from the vehicle at an angle of 90°.

The charging or fueling compartment assembly 1, as shown schematically in the drawings, is characterized in particular by the fact that it also has an indicator panel 4 for displaying icons 5 as needed, the indicator panel 4 being designed as a hidden-until-lit component in which the icon 5 or the icons 5 to be displayed as needed is/are only optically perceptible when a light source of the indicator panel 4 associated with the icon 5 to be displayed as needed is activated.

In FIG. 1, a state is shown in which the indicator panel 4 and the light sources associated with the icons 5 of the indicator panel 4 are not activated, so that the icons 5 of the display panel 4 are not visually perceptible.

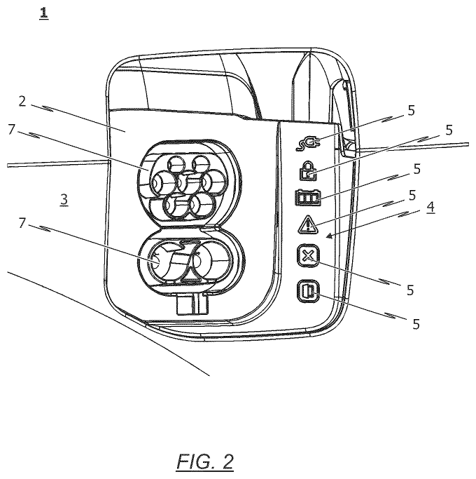

In FIG. 2, on the other hand, a condition is shown in which all icons 5 of indicator panel 4 are visually perceptible.

As can be seen, the icons 5 on indicator panel 4 are in particular marks, signs, images, or letters, although other icons 5, such as words, etc., are also fundamentally conceivable.

In particular, the indicator panel 4 can display a first icon 5 for indicating a position of the cover if required, a second icon 5 for indicating a state of the cover if required, a third icon 5 for indicating a state of charge if required, a fourth icon 5 for indicating a state in which a charging plug is inserted into a charging box 7 of the charging or fueling compartment assembly 1 and is arrested there if necessary, a fifth icon 5 for indicating a charging duration and/or a remaining charging time if necessary, a sixth icon 5 for indicating a state in which an AC charging or a DC charging is taking place, and/or a seventh icon 5 for displaying a status of at least one charging connection of the charging or fueling compartment assembly 1 or for displaying a status of at least one charging connection of a second charging or fueling compartment assembly 1 of the vehicle.

Although not shown in the drawings, the charging or fueling compartment assembly 1 has a sensor system or a sensor system is assigned to the charging or fueling compartment assembly 1. The sensor system is particularly designed to detect a position, in particular the closed position, open position, and/or at least one intermediate position, of the cover, to detect a state of the cover, in particular a locked state and/or an unlocked state of the cover, to detect a state in which a charging plug is inserted into a charging box 7 of the charging or fueling compartment assembly 1 and is arrested there if necessary, and/or to detect a charging state.

The drawings also do not show that the charging or fueling compartment assembly 1 has a control device or that a control device is associated with the charging or fueling compartment assembly 1, which is designed in particular in dependence on a state detected by the sensor system, to activate or deactivate a light source, associated with a corresponding icon 5, of the indicator panel 4, altering a brightness of the light emitted by the light source associated with the icon 5 to be displayed as needed, altering a color of the light emitted by the light source associated with the icon 5 to be displayed as needed, and/or altering a flashing frequency of the light emitted by the light source associated with the icon 5 to be displayed.

A corresponding light source, in particular in the form of an LED or an illuminated film, is assigned to each icon 5 of the indicator panel 4 that is to be displayed as needed.

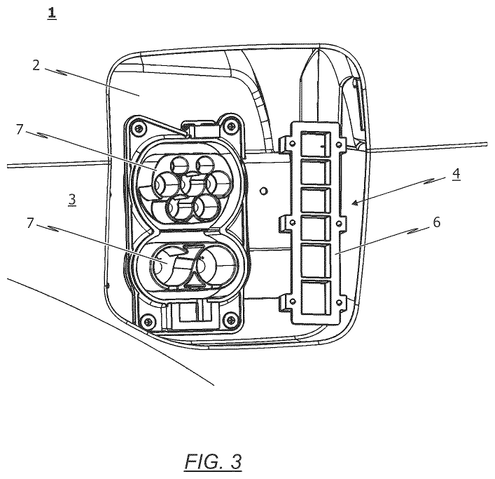

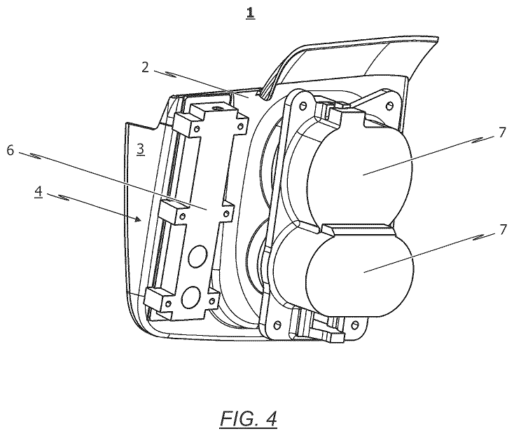

As can be seen in particular from the sectional view in FIG. 3, but also from the rear view in FIG. 4, the indicator panel 4 has a carrier 6 which is used to hold the corresponding light source for the icons 5 to be displayed. It is envisaged that the carrier 6 is segmented accordingly so that the light emitted from a light source associated with a first icon 5 only illuminates the area of the back of the icon to be displayed.

In particular, it is envisaged that the indicator panel 4, in addition to the carrier 6 for the corresponding light source, has a layered structure with a front side for displaying the displayed icons 5 and a rear side that can be illuminated by the light source.

The layer structure can have a translucent top layer, at least in part or zonally, and a stencil layer, with the icons 5 to be displayed as needed on the indicator panel 4 being incorporated into the stencil layer, in particular by engraving, such as laser engraving or electroengraving.

The translucent outer layer is preferably made of a translucent plastic such as polycarbonate (PC), polymethyl methacrylate (PMMA), polyamide (PA), UV-stabilized ABS, polypropylene (PP). However, the translucent top layer can also consist of a translucent polymer or silicone or of glass or a glass-like material.

The translucent top layer preferably has a thickness of about 0.5 mm to 2.0 mm and also preferably has a light transmission T (transmission level) of 5% to 70%, in particular of 5% to 50%, and preferably of 5% to 15% for visible light.

The indicator panel 4 is mounted in the charging or fueling compartment 2 in a dust- and waterproof manner, preferably in a detachable or exchangeable manner.

The disclosure is not limited to the charging or fueling compartment assembly 1 as shown in the drawings, but results from an overview of all features disclosed herein.

In particular, it is conceivable that indicator panel 4 is an integral part of a user interface and has at least one control panel with at least one control element, in particular a touch control element.

The control element can be designed to detect a touch by a user and/or the position of a touch by a user capacitively. The control element is also preferably designed as a hidden-until-lit component, in which the control element is only visually perceptible when a user interface light source assigned to the control element is active.

Alternatively or additionally, the control element can also be designed as a pressure-sensitive slide switch, which is particularly designed to change or be able to change a parameter of a display field of the user interface when, for example, a user exerts pressure along the control element from one position to another.

In principle, it is advantageous for the control element to be designed in such a way that a haptic and/or acoustic feedback signal is given when it is activated.

The control element can be used in particular such that, when actuated, an actuator associated with the cover is activated or deactivated, a lock associated with the cover is activated or deactivated, a charging operation is started, ended, aborted, or interrupted, and/or a charging plug lock associated with a charging box 7 of the charging or fueling compartment assembly 1 is activated or deactivated.

In principle, it is also conceivable that indicator panel 4 has a display device for displaying an image, in particular a changeable image, in particular a static or moving image, as needed. In this case, the display device should preferably be designed as a hidden-until-lit component, in which the image is only visible when the display device is activated.

In particular, thin-film display devices, for example an OLED, a TFT, an LCD, an ITO film display, or an SED display, are suitable as display devices.

While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Charging or fueling compartment assembly
2 Charging or fueling compartment
3 Vehicle body/vehicle outer skin
4 Indicator panel
5 Icon
6 Carriers of the indicator panel
7 Charging port/charging box

What is claimed is:

1. A charging or fueling compartment assembly (1) for vehicles, wherein the charging or fueling compartment assembly (1) comprises the following:
a charging or fueling compartment (2) for insertion into an opening of a vehicle body (3) or into an opening of a vehicle outer skin; and
a cover, which is operatively connected to a mechanism in such a way that the cover can be transferred, relative to the charging or fueling compartment (2), between a closed position that at least partially or regionally covers the charging or fueling compartment (2) and an open position that at least partially or regionally releases the charging or fueling compartment (2);
wherein the charging or fueling compartment assembly (1) further comprises an indicator panel (4) for indicating as needed at least one icon (5) in a form of a marking, a symbol, an image, a letter, or a word,
wherein the indicator panel (4) comprises at least one light source associated with the at least one icon (5) to be indicated in a form of an LED or in a form of a fluorescent film, and
wherein the indicator panel (4) is configured as a hidden-until-lit component, in which the at least one icon (5) to be indicated is only visually perceptible when the at least one light source associated with the at least one icon (5) to be indicated as needed is active.

2. The charging or fueling compartment assembly (1) according to claim 1, wherein the indicator panel (4) comprises the following:
at least one first icon (5) for indicating as needed a position of the cover; and/or
at least one second icon (5) for indicating as needed a state of the cover; and/or
at least one third icon (5) for indicating as needed a state of charge; and/or
at least one fourth icon (5) for indicating as needed a state in which a charging plug is inserted into a charging box (7) of the charging or fueling compartment assembly (1) and, if applicable, locked therein; and/or
at least one fifth icon (5) for indicating as needed a charging duration and/or a remaining charging time; and/or
at least one sixth icon (5) for indicating as needed a state in which an AC charge or a DC charge takes place; and/or
at least one seventh icon (5) for indicating as needed a status of at least one charging port of the charging or fueling compartment assembly (1) or for indicating as needed a status of at least one charging port of a second charging or fueling compartment assembly (1) of the vehicle.

3. The charging or fueling compartment assembly (1) according to claim 1, wherein the charging or fueling compartment assembly (1) comprises a sensor system or wherein the charging or fueling compartment assembly (1) is associated with a sensor system, wherein the sensor system comprises at least one sensor and/or switch, which is configured so as to:
detect a closed position, an open position, and/or at least one intermediate position of the cover; and/or
detect a locked state and/or an unlocked state of the cover; and/or
detect a state in which a charging plug is inserted into a charging box (7) of the charging or fueling compartment assembly (1) and, if applicable, locked therein; and/or
detect a state of charge.

4. The charging or fueling compartment assembly (1) according to claim 3, wherein the charging or fueling compartment assembly (1) comprises a control device, or wherein the charging or fueling compartment assembly (1) is associated with a control device, wherein the control device is configured, as a function of a state detected by the sensor system, so as to:
activate or deactivate the at least one light source associated with the at least one icon (5) to be indicated as needed; and/or
change a brightness of the light emitted by the at least one light source associated with the at least one icon (5) to be indicated as needed; and/or
change a color of the light emitted by the at least one light source associated with the at least one icon (5) to be indicated as needed; and/or
change a flashing frequency of the light emitted by the at least one light source associated with the at least one icon (5) to be indicated as needed.

5. The charging or fueling compartment assembly (1) according to claim 1,
wherein the indicator panel (4) is an integral part of a user interface and comprises at least one control panel having a touch control element.

6. The charging or fueling compartment assembly (1) according to claim 5,
wherein the at least one control element is configured so as to capacitively detect a touch by a user and/or the position of a touch by a user, and wherein the at least one control element is configured as a hidden-until-lit component, in which the control element is only visually perceptible when a light source of the user interface associated with the at least one control element is active.

7. The charging or fueling compartment assembly (1) according to claim 5,
wherein the at least one control element is configured as a pressure-sensitive push switch, which is configured such that a parameter of a display field of the user interface is or can be changed when a pressure exerted by a user is effected along the control element from one position to another position.

8. The charging or fueling compartment assembly (1) according to claim 5,
wherein the at least one control element is configured so as to provide a haptic and/or acoustic feedback signal upon actuation thereof.

9. The charging or fueling compartment assembly (1) according to claim 5, wherein the at least one control element is configured so as to do the following when actuated:
activate or deactivate an actuator associated with the cover; and/or
activate or deactivate a latch associated with the cover; and/or
start, end, cancel, or interrupt a charging operation; and/or
activate or deactivate a charging plug lock associated with a charging box (7) of the charging or fueling compartment assembly (1).

10. The charging or fueling compartment assembly (1) according to claim 1,
wherein the indicator panel (4) comprises an indicating apparatus for indicating a changeable image, and
wherein the indicating apparatus is configured as a hidden-until-lit component, in which the image is only visually perceptible when the indicating apparatus is active.

11. The charging or fueling compartment assembly (1) according to claim 10, wherein the indicating apparatus is configured as a thin-layer indicating apparatus and comprises an OLED, a TFT, an LCD, an ITO film display, or an SED display.

12. The charging or fueling compartment assembly (1) according to claim 1, wherein the indicator panel (4) comprises a carrier (6) for the at least one light source and a layered structure having a front side for displaying the at least one indicated icon (5) and a rear side that can be illuminated by the at least one light source.

13. The charging or fueling compartment assembly (1) according to claim 12, wherein the indicator panel (4) comprises at least two icons to be indicated as needed, each of which is associated with at least one light source, wherein the carrier (6) is segmented such that the light emitted by the at least one light source associated with a first icon (5) illuminates only the region of the rear side of the layered structure in which the first icon (5) is configured, and the light emitted by the at least one light source associated with a second icon (5) illuminates only the region of the rear side of the layered structure in which the second icon (5) is configured.

14. The charging or fueling compartment assembly (1) according to claim 12, wherein the layered structure comprises a cover layer, which is at least partially or regionally translucent, and a mask layer, wherein the at least one icon (5) to be indicated as needed is incorporated into the mask layer by means of engraving, or applied to a surface of the mask layer by means of printing.

15. The charging or fueling compartment assembly (1) according to claim 14, wherein the translucent cover layer is made of a translucent plastic comprising one or more of a polycarbonate (PC), polymethyl methacrylate (PMMA), polyamide (PA), UV-stabilized ABS, polypropylene (PP), or a translucent polymer or silicone, or of glass, having a thickness of 0.5 mm to 2.0 mm, and further having a translucency T (transmission factor) of 5% to 70% for visible light.

16. The charging or fueling compartment assembly (1) according to claim 14, wherein the cover layer is configured so as to be partially or regionally opaque.

17. The charging or fueling compartment assembly (1) according to claim 12, wherein the layered structure, which comprises an electrochromic layer having opaque suspended particles and is electrically switchable, at least regionally, between an opaque state and a transparent or translucent state with the aid of electrical energy supplied by an electrical voltage source.

18. The charging or fueling compartment assembly (1) according to claim 17, wherein the layered structure further comprises a mask layer, wherein the at least one icon (5) to be indicated as needed is incorporated into the mask layer by means of engraving, or applied to a surface of the mask layer by means of printing.

19. The charging or fueling compartment assembly (1) according to claim 12, wherein the layered structure further comprises at least one color layer that is applied at least partially or regionally onto the front or rear side of the cover layer.

20. The charging or fueling compartment assembly (1) according to claim 1, wherein the indicator panel (4) is received in the charging or fueling compartment (2), in a releasable or interchangeable manner, or is integrated in the charging or fueling compartment (2).
